(19) United States
(12) Patent Application Publication
(10) Pub. No.: US 2005/0247290 A1
(43) Pub. Date: Nov. 10, 2005

(54) Triggering method for influencing the opening speed of a control valve in a fuel injector

(76) Inventor: Hans-Christoph Magel, Pfullingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/123,707

(22) Filed: May 6, 2005

(30) Foreign Application Priority Data
May 6, 2004 (DE) 10 2004 022 268.1

(51) Int. Cl. F02M 1/00

(52) U.S. Cl. 123/446

(57) ABSTRACT

The invention relates to a triggering method for triggering a fuel injector having a control valve that activates or deactivates a pressure booster of the fuel injector. The control valve is embodied as a directly controlled solenoid valve whose magnetic coil can be supplied with at least two different triggering current levels to vary the opening speed of the valve member of the control valve. The valve member of the control valve is associated with a hydraulic damper that slows its opening speed.

### BACKGROUND OF THE INVENTION

1. Field of the Invention

It is possible to use both pressure-controlled and stroke-controlled injection systems to supply fuel to combustion chambers of autoignition internal combustion engines. In addition to unit fuel injectors, these fuel injection systems are also embodied in the form of unit pumps and accumulator (common rail) injection systems. Common rail injection systems advantageously permit the injection pressure to be adapted to the load and speed of the engine. It is generally necessary to achieve a high injection pressure in order to achieve high specific loads and reduce engine emissions of internal combustion engines.

2. Description of the Prior Art

DE 101 23 910.6 relates to a fuel injection system that is used in an internal combustion engine. Fuel injectors supply fuel to the combustion chambers of the engine. A high-pressure source acts on the fuel injectors; the fuel injection system designed according to DE 101 23 910.6 also includes a pressure booster that has a moving pressure boosting piston, which separates a chamber that can be connected to the high-pressure source from a high-pressure chamber connected to the fuel injector. The fuel pressure in the high-pressure fuel chamber can be varied by filling a differential pressure chamber of the pressure booster with fuel or by emptying fuel from this pressure chamber.

The fuel injector has a moving closing piston for opening and closing injection openings oriented toward the combustion chamber. The closing piston protrudes into a closing pressure chamber so that fuel pressure can be exerted on it. This generates a force that acts on the closing piston in the closing direction. The closing pressure chamber and an additional chamber are comprised by a shared working chamber; all of the partial regions of the working chamber are connected to one another continuously to permit the exchange of fuel.

With the design known from DE 101 23 910.6, by triggering the pressure booster by means of the differential pressure chamber, it is possible to keep the triggering losses in the high-pressure fuel system significantly low in comparison to a triggering by means of a working chamber that is connected to the high-pressure fuel source intermittently. In addition, the high-pressure chamber is only depressurized down to the pressure level of the common rail and not down to the leakage pressure level. On the one hand, this improves the hydraulic efficiency and on the other hand, it permits a more rapid pressure reduction down to the system pressure level (pressure level in the common rail), thus permitting intervals between the injection phases to be significantly shortened.

DE 102 29 418 relates to a fuel injection system for injecting fuel into the combustion chambers of an internal combustion engine. The fuel injection system has common rail, a pressure booster, and a metering valve. The pressure booster has a working chamber and a control chamber, which are separated from each other by an axially moving piston. A pressure change in the control chamber of the pressure booster causes a pressure change in a compression chamber that acts on a nozzle chamber via a fuel inlet. The nozzle chamber encompasses an injection valve member, which can be embodied, for example, in the form of a nozzle needle. A nozzle spring chamber that acts on the injection valve member can be filled on the high-pressure side from the compression chamber of the pressure booster via a line that contains an inlet throttle restriction. On the outlet side, the nozzle spring chamber is connected to a chamber of the pressure booster via a line that contains an outlet throttle restriction.

DE 102 29 415 relates to a device for needle stroke damping in pressure-controlled fuel injectors. The fuel injection apparatus includes a fuel injector, which, when a high-pressure source is provided, can be acted on with highly pressurized fuel and can be actuated by means of a metering valve. The injection valve is associated with a damping element, which can move independently of it and delimits a damping chamber. The damping element has at least one overflow conduit for connecting the damping chamber to an additional hydraulic chamber.

Finally U.S. application Ser. No. 10/910,346 discloses an on/off valve with pressure compensation for a pressure booster-equipped fuel injector. According to this design, the fuel injector has a pressure booster that is supplied with highly pressurized fuel from a pressure source. A booster piston separates a working chamber of the pressure booster from a differential pressure chamber of the pressure booster. An on/off valve executes the depressurization and pressurization of the differential pressure chamber of the pressure booster. A control line connects this on/off valve to the differential pressure chamber of the pressure booster. A pressure chamber in an injection valve is connected to a compression chamber of the pressure booster via a pressure chamber supply line. The on/off valve is embodied in the form of a directly switching 3/2-way valve whose valve needle is pressure balanced and has both a sealing seat and a sliding seal.

The above-outlined embodiments according to the prior art equipped with only one valve have the disadvantage that such fuel injectors lack flexibility in the injection pressure curve (rate-shaping) in comparison to fuel injectors equipped with two actuators that are independent of each other.

### OBJECT AND SUMMARY OF THE INVENTION

In view of the technical disadvantages of the prior art outlined above, the present invention proposes a control method that uses different opening speeds of the control valve to shape the injection pressure curves of fuel injectors. Using the control method proposed according to the present invention, the activation current level of a solenoid valve is used to influence the opening speeds of the control valve. This makes it possible to influence the injection rate, i.e. the quantity of fuel injected over time into the combustion chamber of the autoignition internal combustion engine. This makes it possible to adjust the injection rate by means of the control unit associated with the internal combustion engine. Adjusting the injection rate by means of the motor control unit associated with the engine advantageously permits the injection quantity to be adapted to the respective operating conditions of the autoignition internal combustion engine.

The triggering method proposed according to the present invention makes it possible to use a directly switching 3/2-way valve as the control valve for controlling the fuel injector. The opening movement of this control valve is slowed by means of a damping unit. It is possible to influence the opening speeds by selecting different activation current levels of a solenoid valve. If the control edges of the 3/2-way valve are appropriately designed, then different opening speeds of the control valve can be used to shape the injection pressure, i.e. the pressure that prevails at the combustion chamber end of the injection valve member.

In addition, since only one control valve is used for the fuel injector, there is no increase in the production engineering cost of manufacturing and assembling the fuel injector that is operated using the triggering method proposed according to the present invention. Likewise, the cost related to a modification of the control unit used in an internal combustion engine remains low since only one output stage is required for each fuel injector used in the internal combustion engine.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows the hydraulic circuit diagram of a fuel injector that can be operated using the triggering method proposed according to the present invention,

FIG. 2 shows the level of current that can be set in a solenoid valve in order to achieve different opening speeds,

FIG. 3 shows the stroke curve of a valve member of a control valve,

FIG. 4 shows the pressure level occurring at the combustion chamber end of an injection valve member, and

FIG. 5 shows the stroke curve of the injection valve member of the fuel injector from FIG. 1.

### DESCRIPTION OF THE PREFERRED EMBODIMENTS

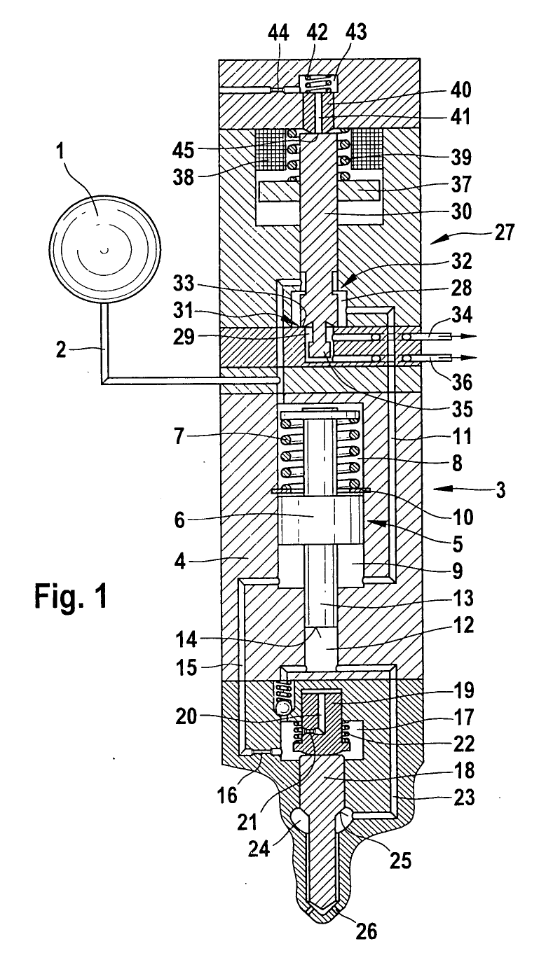

FIG. 1 shows a fuel injector that can be actuated using the triggering method proposed according to the present invention for a control valve that actuates this fuel injector, and a common rail 1 that is connected to a fuel injector 3 via a high-pressure line 2. The fuel injector 3 has an injector housing 4 that is preferably comprised of multiple parts to facilitate assembly and contains a pressure booster 5. The pressure booster 5 has a working chamber 8 continuously connected to the common rail 1, a compression chamber 12, and a differential pressure chamber 9 that is used to activate or deactivate the pressure booster.

The pressure booster 5 contains a first piston part 6, which is acted on by means of a return spring 7 that returns the first piston part 6 of the pressure booster 5 into its neutral position. The restoring spring 7 rests against an annular stop 10 contained in the working chamber 8 of the pressure booster 5. The pressure booster 5 also has a second piston part 13, whose end surface 14 exerts pressure on the compression chamber 12. An overflow line 15 that contains a first throttle restriction 16 extends from the differential pressure chamber 9 of the pressure booster 5 and feeds into a pressure chamber 17.

The pressure chamber 17 contains a damping piston 19 through which a bore 20 passes that contains a second throttle restriction 21. The damping piston 19 is acted on by a spring 22 that is supported against a wall of the pressure chamber 17 and against an annular stop of the damping piston 19. In the embodiment form shown in FIG. 1, the damping piston 19 has a rounded end surface that acts on an upper end surface of an injection valve member 18, which is comprised of one piece in this instance.

The injection valve member 18 is provided with a pressure shoulder 25 in the region of a nozzle chamber 24. A nozzle chamber inlet 23 connects the nozzle chamber 24 to the compression chamber 12 of the pressure booster 5. In accordance with the pressure boosting ratio of the pressure booster 5, which depends on its design, when the pressure booster is actuated through depressurization of the differential pressure chamber 9, fuel compressed in the compression chamber 12 flows through the nozzle chamber inlet 23 into the nozzle chamber 24 and from there, along the injection valve member 18 to injection openings 26 at the combustion chamber end of the fuel injector 3.

The differential pressure chamber 9 of the pressure booster 5 communicates with a first hydraulic chamber 28 of a control valve 27 via the control line 11. The control valve 27 is preferably embodied in the form of a directly controlled 3/2-way valve. In addition to the first hydraulic chamber 28, the control valve 27 has a second hydraulic chamber 29 that constitutes part of the low-pressure region. The control valve 27 also has a valve member 30. When the housing of the control valve 27 is comprised of multiple parts, it contains a first control edge 31 in the region of a flat seat 33 and a second control edge 32 that is provided on a housing part of the multipart housing of the control valve 27. Both a first return 34 and a second return 36 branch off from the second hydraulic chamber 29 of the control valve 27 and lead into the low-pressure region of the fuel injection system. When the valve member 30 is in the closed position, the closed flat seat 33 seals the second hydraulic chamber 29 off from the first hydraulic chamber 28. The valve member 30 of the control valve 27 has a piston extension 35, which, in the closed position of the flat seat 33 shown in FIG. 1, is positioned in the second hydraulic chamber 29 of the control valve 27.

The vertically moving valve member 30 of the control valve 27 supports an annular magnet armature plate 37, which faces a magnetic coil 38 that can be supplied with current. A closing spring 39 acts on the valve member 30 in the closing direction so that when the magnetic coil 38 of the control valve 27 is not being supplied with current, the flat seat 33 is closed in relation to the low-pressure side second hydraulic chamber 29.

A hydraulic damper 40 is located at the end surface opposite from the second hydraulic chamber 29 of the valve member 30. The hydraulic damper 40 has a through bore 41 passing through it and is prestressed by means of a spring element 42. The spring element 42 is contained inside a damper chamber 43. Diverted fuel volume is conveyed out of this damping chamber 43 into the low-pressure region of the fuel injection system via the third throttle restriction 44. The hydraulic damper 40 and the valve member 30 rest against each other along a contact surface 45 in the switched position of the control valve 27 depicted in FIG. 1, but are separate components.

In the deactivated idle state of the pressure booster 5, the control valve 27 is closed due to the action of the closing spring 39. As a result, the first control edge 31 beneath the flat seat 33 on the valve member 30 is closed. Consequently, the control line 11 is also closed so that in the differential pressure chamber 9 of the pressure booster 5, the same pressure prevails as in the working chamber 8 connected to the common rail 1. The pressure booster 5 is deactivated since it is pressure-balanced and no pressure boosting takes place. The closed flat seat 33 disconnects the control line 11 from the first return 34 and from the second return 36 into the low-pressure region of the fuel injection system.

The differential pressure chamber 9 is depressurized to trigger the pressure booster 5. To initiate this, the control valve 27 is activated, i.e. opened. The magnetic coil 38 is supplied with current so as to attract the magnet armature 37 counter to the action of the closing spring 39, as a result of which the flat seat 33 at the first control edge 31 of the control valve 27 is opened. Fuel flowing out of the differential pressure chamber 9 via the control line 11 travels into the first hydraulic chamber 28 and, via the open first control edge 31, travels to the first return 34 and the second return 36 to the low-pressure side of the fuel injection system. This causes the differential pressure chamber 9 of the pressure booster 5 to be decoupled from the common rail 1 and discharges the pressure from the differential pressure chamber 9 into the returns 34, 36 in the low-pressure region. Because the second piston part 13 of the pressure booster then travels into the compression chamber 12, the pressure therein increases in accordance with the boosting ratio of the pressure booster 5 and flows into the nozzle chamber 24 via the nozzle chamber inlet 23. Hydraulic force acting on the pressure shoulder 25, which is provided on the potentially one-piece injection valve member in the region of the nozzle chamber 24, opens the injection valve member 18, thus unblocking the injection openings 26 at the combustion chamber end of the fuel injector 3 so that it can inject fuel into a combustion chamber, not shown in FIG. 1, of an internal combustion engine.

To terminate the injection, the control valve 27 is once again deactivated, i.e. closed. When the supply of current to the magnetic coil 38 of the control valve 27 is suspended, the action of the closing spring 39 moves the valve member of 30 back into its closed position. In the closed position, the first control edge 31 beneath the flat seat 33 is closed. As a result, a pressure increase in the differential pressure chamber 9 of the pressure booster 5 occurs via the high-pressure line 2 extending from the common rail 1, the first hydraulic chamber 28, and the control line 11 so that the pressure booster 5 travels into its neutral position. During the closing movement of the valve member 30 of the control valve 27, the second control edge 32 of the control valve 27 is opened. The system pressure building up in the differential pressure chamber 9 of the pressure booster 5, i.e. the pressure level that prevails in the common rail 1, deactivates the pressure booster 5. The second piston part 13 travels out of the compression chamber 12 and, due to the decreasing pressure in the nozzle chamber 24, the injection valve member 18 is moved back into its position that closes the injection openings 26.

The hydraulic damper 40 is located above the valve member 30, which can move in the vertical direction when the magnetic coil 38 is supplied with current. This hydraulic damper 40 achieves a slow, essentially linear opening motion of the one-piece injection valve member 18 according to the depiction in FIG. 1. During the opening of the valve member 30, i.e. when the magnetic coil 38 is being supplied with current, the hydraulic damper 40 conveys the displaced quantity via the third throttle restriction 44 into a low-pressure region, not shown in FIG. 1, of the fuel injection system. The hydraulic damper 40 slows the opening motion of the valve member 30 when the magnetic coil 38 is supplied with current. The hydraulic damper 40, however, does not influence the closing motion of the valve member 30 of the control valve 27. This is because when the valve member 30 closes, i.e. when the supply of current to the magnetic coil 38 is interrupted, the action of the closing spring 39 can achieve a rapid closing motion of the valve member 30 during which the hydraulic damper 40 separates from the valve member 30 at a contact surface 45. As a result, the valve member 30 can travel unhindered into its closed position whereupon the damper chamber 43 is rapidly filled via the through bore 41 of the hydraulic damper 40. This means that the hydraulic damper 40 can be reset to its starting position very quickly. This is particularly significant with regard to rapid sequences of injection events occurring at high speeds of autoignition internal combustion engines.

The opening speed of the valve member 30 of the control valve can be set through the dimensioning of the third throttle restriction 44 associated with the damping chamber 43. The opening speed of the valve member 30 that occurs also depends on the magnetic force achieved when the magnetic coil 38 of the control valve 27 is supplied with current. The magnetic force of the magnetic coil 38 of the control valve 27 can be adjusted by means of the level of current supplied.

If the magnetic coil 38 is supplied with a low level of current, then the control valve 27, i.e. the valve member 30, opens more slowly. This makes it possible to achieve a delayed, gradually occurring pressure buildup at the beginning of an injection phase, which yields an essentially ramp-shaped curve of the injection rate.

However, if the magnetic coil 38 of the control valve 27 is supplied with a second, higher activation current, then the control valve 27 opens quickly. This makes it possible to achieve a more rapid pressure buildup at the beginning of a respective injection, which yields an injection rate with a rectangular curve.

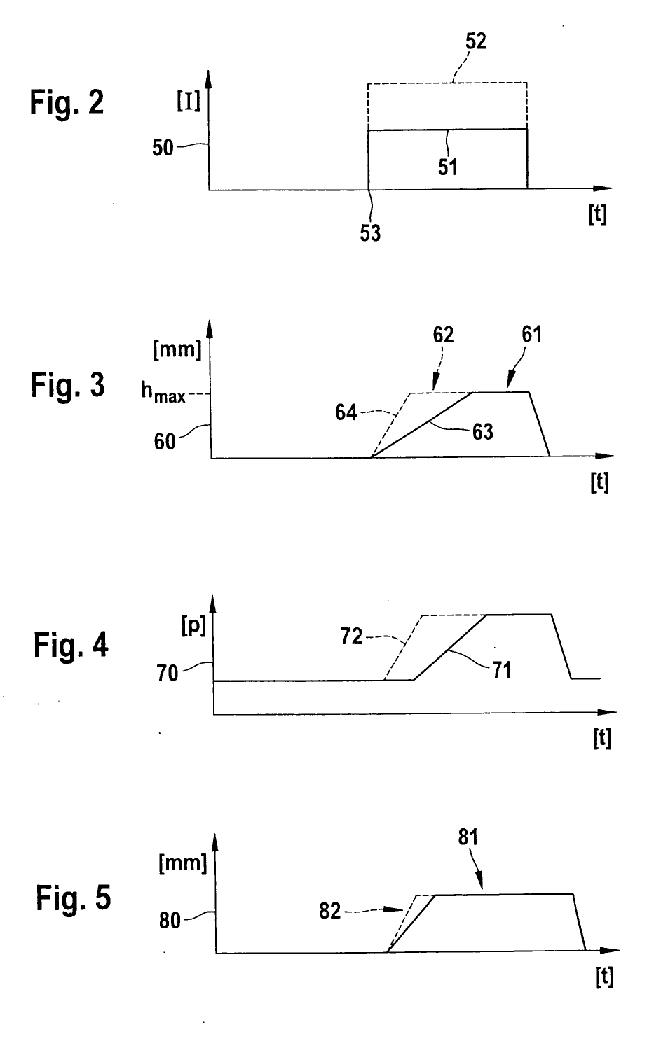

FIG. 2 shows various possibilities for current supply to the control valve for actuating the fuel injector. The current supply curve 50 of the magnetic coil 38 is plotted over time [t]. At a triggering time 53, the magnetic coil 38 can be supplied with current either at the first triggering current level 51 or at the second triggering current level 52 depicted with dashed lines.

FIG. 3 shows stroke curves of the control valve that correspond to the current supply level. If the valve member 30 of the control valve 27 is triggered at the first triggering current level 51, i.e. the magnetic coil 38 is supplied with a lower current level, then the valve member 30 of the control valve 27 opens more slowly. This yields a first ramp 63 with a more gradual slope.

FIG. 4 shows the pressure curves occurring at the injection valve member. If the magnetic coil 38 is supplied with the first triggering current level 51 shown in FIG. 2 and the first stroke curve 61 shown in FIG. 3 occurs, then this yields a first pressure curve 71 at the injection valve member.

FIG. 5 shows stroke curves of the injection valve member. The first stroke curve 81 of the potentially one-piece injection valve member 18 corresponding to the first triggering current level 51 of the magnetic coil 38 of the control valve 27.

FIG. 2 also shows in dashed lines the power supply curve 50 of the magnetic coil 38 when a second triggering current level 52 is selected. In this instance, a second stroke curve 62 according to FIG. 3 occurs, which is characterized by a second ramp 64 that differs from the first ramp 63 at the first triggering current level 61 of the magnetic coil 38 by virtue of its significantly steeper slope. This yields the second pressure curve 72 in the injection nozzle according to FIG. 4, which results in an injection rate that extends in an essentially rectangular curve.

FIG. 5 also shows the second stroke curve 82 that occurs when the magnetic coil 38 is supplied with the second triggering current level 52, which differs only slightly from the first stroke curve 81 aside from a steeper increase at the beginning.

In addition to the different triggering current levels 51 and 52 with which the magnetic coil 38 of the control valve 27 can be supplied, the opening speed of the valve member 30 can also be adjusted by means of the third throttle restriction 44. The slowing of the opening speed is also achieved by means of the hydraulic damper 40 accommodated in the upper region of the control valve 27, but thanks to the division of the valve member 30, this damper does not affect the closing of the injection valve member 18.

The injection shape depicted in FIGS. 3 through 5 with regard to the injection rates that can be achieved using the triggering method proposed according to the present invention for a control valve 27 can also be varied by means of the control unit respectively associated with the autoignition internal combustion engine and optimally adapted to the requirements of the internal combustion engine within corresponding characteristic fields.

The foregoing relates to preferred exemplary embodiments of the invention, it being understood that other variants and embodiments thereof are possible within the spirit and scope of the invention, the latter being defined by the appended claims.

1. A method for triggering a fuel injector (3) for injecting fuel into combustion chambers of an internal combustion engine in which the fuel injector (3) has a pressure booster (5) that is supplied with highly pressurized fuel via a connection to a common rail (1) and is activated and deactivated by means of a control valve (27), which control valve is embodied in a directly switching form, the method comprising varying the opening speed of a valve member (30) of the control valve (27) in order to shape the injection pressure curve (7).

2. The method according to claim 1, wherein the opening speed of the valve member (30) is varied by means of at least two different triggering current levels (51, 52) of the magnetic coil (38).

3. The method according to claim 1, wherein the opening speed of the valve member (30) of the control valve (27) is slowed by a hydraulic damping means associated with the valve member (30).

4. The method according to claim 3, further comprising conveying away a displaced fuel quantity via a third throttle restriction (44) during the opening of the valve member (30).

5. The method according to claim 1, wherein when the valve member (30) of the control valve (27) closes, the hydraulic damper (40) and the valve member (30) separate from each other along a contact surface (45).

6. The method according to claim 5, wherein when the valve member (30) of the control valve (27) closes, a damping chamber (43) is filled via a through bore (41) provided in the hydraulic damper (40).

7. The method according to claim 2, further comprising utilizing at a first triggering current level (51) of the magnetic coil (38) of the control valve (27) to produce a slow opening of the valve member (30), accompanied by a delayed pressure buildup at the beginning of the fuel injection, thus yielding a first ramp-shaped injection rate (63, 71).

8. The method according to claim 2, further comprising supplying the magnetic coil (38) with a second triggering the level (52) to produce a rapid opening of the valve member (30) occurs, accompanied by a rapid pressure increase at the beginning of the injection as well as an injection rate (64, 72) that extends in the form of a rectangular curve.

9. The method according to claim 1, further comprising utilizing the control valve (27) to controls the pressure booster (5) and the injection valve member (18), activating or deactivating the pressure booster (5) through the depressurization or pressurization of its differential pressure chamber (9), and maintaining the working chamber (8) of the pressure booster (5) in continuous communication with the common rail (1).

10. A fuel injection system for triggering a fuel injector (3) according to claim 1, wherein the control valve (27) comprises a hydraulic damper (40), which is associated with the injection valve member (30), the hydraulic damper (40) having a through bore (41) feeding into a control chamber (43) that can be depressurized via a throttle restriction (44).

11. The fuel injection system according to claim 10, further comprising a closing spring (39) acting on the valve member (30) of the control valve (27) in the closing direction.

12. The fuel injection system according to claim 10, further comprising a spring (42) placing the hydraulic damper (40) against the valve member (30).

13. The fuel injection system according to claim 10, further comprising a magnet armature plate (27) and a magnetic coil (38), the valve member (30) of the control valve (27) supports the magnet armature plate (37) underneath the magnetic coil (38), the valve member (30) having a seat (33) for closing a second hydraulic chamber (29).
